(19) United States
(12) Patent Application Publication
(10) Pub. No.: US 2017/0301891 A1
(43) Pub. Date: Oct. 19, 2017

(54) MULTILAYER THIN FILM DEVICE ENCAPSULATION USING SOFT AND PLIABLE LAYER FIRST

(71) Applicant: Applied Materials, Inc., Santa Clara, CA (US)

(72) Inventors: Byung-Sung Kwak, Portland, OR (US); Lizhong Sun, San Jose, CA (US); Giback Park, San Jose, CA (US); Michael Yu-Tak Young, Cupertino, CA (US); Jeffrey L. Franklin, Albuquerque, NM (US); Miaojun Wang, San Jose, CA (US); Dimitrios Argyris, Los Altos, CA (US)

(21) Appl. No.: 15/462,220

(22) Filed: Mar. 17, 2017

Related U.S. Application Data
(63) Continuation-in-part of application No. 15/338,958, filed on Oct. 31, 2016.
(60) Provisional application No. 62/322,415, filed on Apr. 14, 2016.

(51) Int. Cl. H01M 2/02; H01M 4/525

(52) U.S. Cl. CPC H01M 2/0275; H01M 4/525; H01M 2/0287; H01M 2300/0065

(57) ABSTRACT

A thin film device may include an active device region, where the active device region comprises a selective expansion region. The thin film device may further include a polymer layer disposed adjacent to the active device region and encapsulating the active device region, the polymer layer comprising a plurality of polymer sub-layers. A first polymer sub-layer of the plurality of polymer sub-layers may have a first hardness, while a second polymer sub-layer of the plurality of polymer sub-layers has a second hardness, the second hardness being different from the first hardness.

### RELATED APPLICATIONS

This application is a continuation in part of and claims priority to U.S. patent application Ser. No. 15/338,958, U.S., filed Oct. 31, 2016, entitled “Multilayer thin film device encapsulation using Soft and pliable Layer First,” and further claims priority to provisional patent application No. 62/322,415, filed Apr. 14, 2016, entitled “Volume Change Accommodating TFE Materials,” each of which application is incorporated by reference herein in its entirety.

### FIELD

The present embodiments relate to thin film encapsulation (TFE) technology used to protect active devices, and more particularly to encapsulating electrochemical devices.

### BACKGROUND

Thin film encapsulation technology is often employed in devices, where the devices are purely electrical devices or electro-optical devices, such as Organic Light Emitting Diodes (OLED). Other than possibly experiencing a small global thermal expansion from heat generation during the device operation, these electrical devices and electro-optical devices do not exhibit volume changes during operation, since just electrons and photons are transported within the devices during operation. Such global effects due to global thermal expansion of a device may affect in a similar fashion every component of a given device including the thin film encapsulant, and thus, may not lead to significant internal stress. In this manner, the functionality of the thin film encapsulant in a purely electrical device or electro-optic device may not be affected by thermal expansion during operation.

Notably, in an electrochemical device (“chemical” portion), matter such as elements, ions, or other chemical species having a physical volume (the physical volume of electrons may be considered to be approximately zero) are transported within the device during operation with physical volume move. For known electrochemical devices, e.g., thin film batteries (TFB) based upon lithium (Li), Li is transported from one side to the other side of a battery as electrons move around an external circuit connected to the TFB, where the electrons move in an opposite direction to the chemical and elements. One particular example of the volume change experienced by a Li TFB is as follows. When charging a thin film battery having a lithium-containing cathode such as a lithium cobalt oxide (LiCoO₂) cathode (˜15 μm to 17 μm thick LiCoO₂), an amount of Li equivalent to several micrometers thick layer, such as 6 micrometers (given 100% dense material), may be transported to the anode when loading is approximately 1 mAhr/cm². When Li returns to the cathode in a discharge process, the same volume reduction may result on the anode (assuming 100% efficiency). The cathode may also undergo a volume change during a charging and discharging cycle, while such changes are smaller as compared to the anode. For example, the volume of a cathode formed from LiCoO₂ material may contract during charging when Li is extracted from the crystalline lattice, while the volume change is relatively small compared to volume changes occurring at the anode.

As such, known thin film encapsulant approaches may be lacking in providing the ability to accommodate such volume change in a robust manner, where the thin film encapsulant continues to provide protection of the electrochemical device during repeated cycling of the device.

With respect to these and other considerations the present disclosure is provided.

### BRIEF SUMMARY

In one embodiment, a thin film device may include an active device region, where the active device region comprises a selective expansion region. The thin film device may also include a polymer layer disposed adjacent to the active device region and encapsulating the active device region, where the polymer layer comprises a plurality of polymer sub-layers. A first polymer sub-layer of the plurality of polymer sub-layers may have a first hardness, and a second polymer sub-layer of the plurality of polymer sub-layers may have a second hardness, where the second hardness is different from the first hardness.

In another embodiment, a thin film battery may include an active device region, where the active device region includes a lithium-containing cathode; a solid state electrolyte, disposed on the cathode; and an anode disposed on the solid state electrolyte. The thin film battery may further include a thin film encapsulant disposed adjacent to the anode and encapsulating at least a portion of the active device region. The thin film encapsulant may include a first polymer layer, where the first polymer layer comprises a plurality of polymer sub-layers. A first polymer sub-layer of the plurality of polymer sub-layers may have a first hardness, and a second polymer sub-layer of the plurality of polymer sub-layers may have a second hardness, the second hardness being different from the first hardness. The thin film encapsulant may also include a rigid layer, disposed on the first polymer layer.

In a further embodiment a thin film battery may include a lithium-containing cathode; a solid state electrolyte, disposed on the cathode; an anode disposed on the solid state electrolyte, the anode comprising a selective expansion region; and a thin film encapsulant disposed adjacent to the anode. The thin film encapsulant may include a first polymer layer including a first polymer sub-layer, disposed on the selective expansion region, where the first polymer sub-layer has a first hardness. The first polymer layer may also include a second polymer sub-layer, disposed on the first polymer sub-layer, where the second polymer sub-layer has a second hardness, different from the first hardness. The thin film encapsulant may also include a first rigid layer, disposed on the first polymer layer, a second polymer layer disposed on the first rigid layer, and a second rigid layer disposed on the second polymer layer.

### BRIEF DESCRIPTION OF THE DRAWINGS

FIG. 1A illustrates a thin film device according to various embodiments of the disclosure;

FIG. 1B provides one embodiment of a thin film encapsulant, arranged as a dyad structure, according to embodiments of the disclosure;

FIG. 2 illustrates a second instance of operation of the thin film device of FIG. 1A, representing a second state of the thin film device;

FIG. 3 illustrates a thin film battery in accordance with embodiments of the disclosure;

FIG. 4 shows a thin film battery in accordance with other embodiments of the disclosure in a first device state;

FIG. 5 shows another depiction of the thin film battery of FIG. 4 in a second device state;

FIG. 6 shows an embodiment of a thin film battery structure that may form part of a thin film battery;

FIG. 7 shows another embodiment of a thin film battery structure that may form part of a thin film battery;

FIG. 8A shows an embodiment of a thin film battery, according to various embodiments of the disclosure;

FIG. 8B shows details of a thin film encapsulant according to embodiments of the disclosure;

FIG. 8C shows an embodiment of a thin film battery, according to other embodiments of the disclosure; and

FIG. 8D shows details of a thin film encapsulant according to embodiments of the disclosure.

### DETAILED DESCRIPTION

The present embodiments will now be described more fully hereinafter with reference to the accompanying drawings, where some embodiments are shown. The subject matter of the present disclosure may be embodied in many different forms and are not to be construed as limited to the embodiments set forth herein. These embodiments are provided so this disclosure will be thorough and complete, and will fully convey the scope of the subject matter to those skilled in the art. In the drawings, like numbers refer to like elements throughout.

The present embodiments are related to thin film encapsulant structures and technology, where the thin film encapsulant is used to minimize ambient exposure of active devices. In the present embodiments, an active device may form an “active device region” within a device including a thin film encapsulant. The present embodiments provide novel structures and materials combinations for thin film encapsulants, where the thin film encapsulants may be used to encapsulate active devices.

In various embodiments, a device such as a thin film device, is provided with a novel thin film encapsulant encapsulating an active device. Examples of active devices include a piezoelectric device, shape memory alloy device, or microelectromechanical system (MEMS) device in some embodiments. In other embodiments, the film device may be an electrochemical device. Examples of electrochemical devices include electrochromic windows and thin film batteries wherein the active component materials are highly sensitive/reactive to moisture or other ambient materials. To this end, in various embodiments known electrochemical devices such as thin film batteries may be provided with encapsulation to protect the active component materials.

The present embodiments also address a problem encountered in devices such as thin film batteries, where a large physical volume change (expansion and contraction) may take place during the operation of the device. More particularly, as noted, volume changes in a device such as a Li thin film battery may take place in a localized or non-uniform manner in a “selective expansion” region, such as an anode region. Various embodiments of the disclosure provide appropriate structures and appropriate thin film encapsulant materials and methods of applying such materials in a device, such as a thin film battery, resulting in device structures meeting stringent thin film encapsulant requirements.

In various embodiments, a thin film device is provided with a novel combination of thin film encapsulant material and/or structures. The thin film device, such as a thin film battery or electrochromic window, may include a device stack composed of active layers, as well as the thin film encapsulant, which thin film encapsulant may also constitute a multilayer structure.

According to embodiments of the disclosure, a thin film device may include an active device region and a thin film encapsulant. The active device region may include a source region comprising the diffusant; and a selective expansion region, wherein transport of the diffusant takes place reversibly between the source region and the selective expansion region.

In embodiments where the thin film device is a Li thin film battery, a cathode may act as the source region and may include a cathode such as LiCoO₂ or similar material. In the case of electrochromic windows, the concomitant change in volume of a given electrode region may be smaller than in thin film batteries. In embodiments of a Li thin film battery, an anode may act as a selective expansion region, where a large volume change takes place selectively in the selective expansion region, as opposed to other regions in the thin film device.

In embodiments of a Li thin film battery, an anode may act as a selective expansion region, where a large volume change takes place selectively in the selective expansion region, as opposed to other regions in the thin film device.

To accommodate changes in volume in a selective expansion region, various embodiments provide materials and/or structures in a thin film encapsulant, where the thin film encapsulant is effective to accommodate volume expansion, as well as contraction in the selective expansion region, rendering a more robust thin film device.

In various embodiments of the disclosure, a novel thin film encapsulant is arranged adjacent a selective expansion region of a thin film device, such as an anode, where the thin film encapsulant includes a stack of layers. In particular embodiments, the thin film encapsulant includes a first layer, where the first layer is disposed immediately adjacent the selective expansion region and is formed from a soft and pliable material capable of accommodating a change in physical volume in the selective expansion region. The thin film encapsulant may further include a second layer adjacent the first layer, where the second layer is a rigid metal layer or rigid dielectric layer, and where the rigid dielectric layer or rigid metal layer is less pliable than the first layer. An advantage of a rigid metal layer is the rigid metal layer may provide strength while being less brittle than a rigid dielectric layer.

According to various embodiments, the thin film encapsulant of a thin film encapsulant may encapsulate at least portions of the source region and the selective expansion region. In various embodiments, the thin film encapsulant, at least in a portion adjacent the selective expansion region, may reversibly vary thickness from a first thickness to a second thickness in order to accommodate changes in volume or thickness of materials in the selective expansion region. For example, in a thin film battery where an anode or a portion of an anode may constitute a selective expansion region, the anode may change in thickness by several micrometers as a result of lithium migration, between a charged state and a discharged state in the thin film battery. In the present embodiments, the thin film encapsulant may expand or contract in thickness to accommodate the increase or decrease in anode thickness, resulting in less stress, less mechanical failure, and better protection of the active device of a thin film device.

In particular embodiments, and as detailed below, a largest fraction of the reversible contraction and expansion of the thin film encapsulant may take place in a first layer of the thin film encapsulant. In particular, the first layer may be a soft and pliable layer, and second layer of the thin film encapsulant may be a permeation blocking layer. The second layer may be a rigid metal layer or rigid dielectric layer, acting as a diffusion barrier such as a moisture barrier or gas barrier, or a barrier to diffusion of other species.

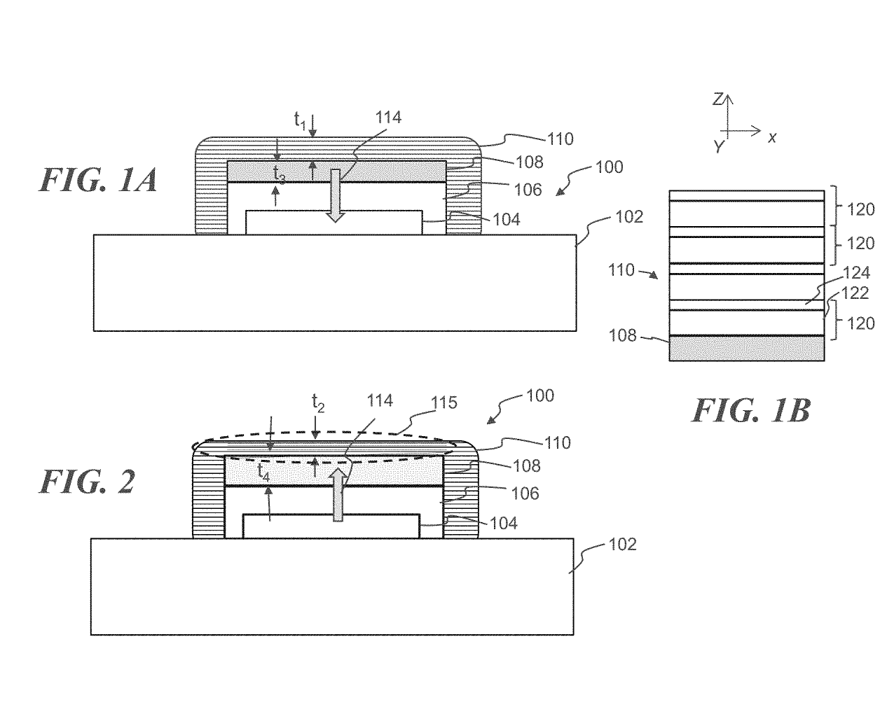

Turning now to FIG. 1A there is shown a thin film device 100 according to embodiments of the disclosure. The thin film device 100 may constitute an electrochemical device such as a thin film battery, electrochromic window, or other electrochemical device. In the embodiment of FIG. 1A, the thin film device 100 may include a substrate base, referred to as the substrate 102, and a source region 104 disposed on the substrate 102. In various embodiments, the source region 104 may represent a cathode of a thin film device such as a thin film battery or an electrochromic window. The source region 104 may act as a source of a diffusant such as lithium, where the diffusant may reversibly diffuse between the source region 104 and to the selective expansion region 108. The thin film device 100 may also include an intermediate region 106 disposed on the source region and a selective expansion region 108 disposed on the intermediate region 106. The selective expansion region 108 may be an anode, for example, of a thin film device. In the instance shown in FIG. 1A, the thin film device 100 may represent a thin film battery in a first device state, such as a discharged state, where the battery is not charged, meaning a diffusant 114, such as lithium, is depleted from the anode.

The thin film device 100 further includes a thin film encapsulant 110, where the thin film encapsulant 110 may include a plurality of layers as suggested in FIG. 1A. The thin film encapsulant 110 is disposed immediately adjacent the selective expansion region 108. In this example, the selective expansion region 108 remains relatively contracted, while the thin film encapsulant 110 is relatively expanded or relaxed, as represented by the first thickness t₁. As shown in FIG. 1B, the thin film encapsulant 110 may include a first layer 122, where the first layer 122 is disposed immediately adjacent the selective expansion region 108, and where the first layer 122 comprises a soft and pliable material. In various embodiments, the first layer 122 may be a polymer layer, where the polymer layer is a soft and pliable layer, enabling the polymer layer to reversibly expand and contract. In various embodiments, the term “polymer layer” as referred to herein, may constitute a polymer layer stack where the polymer layer stack includes at least one polymer layer, and may include multiple layers, which layers may be referred to as sub-layers. Accordingly, the first layer 122 may constitute a polymer layer stack including multiple sub-layers of different polymers, where at least one sub-layer is soft and pliable.

In various embodiments, the first layer 122 may be a getter/absorbent infused polymer, a porous low dielectric constant material, a silver paste, an epoxy, a printed circuit board material, or a photo-resist material, and a combination thereof. In addition to the aforementioned materials, particular examples of suitable polymer materials include silicone, rubber, urethane, polyurethane, polyurea, polytetrafluoroethylene (PTFE), parylene, polypropylene, polystyrene, polyimide, nylon, acetal, ultem, acrylic, epoxy, and phenolic polymers. The embodiments are not limited in this context.

In various embodiments a second layer 124 of the thin film encapsulant 110 may be disposed on the first layer 122. The first layer 122 and the second layer 124 may together form a first dyad, shown as dyad 120. In various embodiments, the dyad 120 may act as a “functional dyad” where at least one layer of the functional dyad provides a diffusion barrier to contaminants such as moisture and gas species, preventing moisture and gas diffusion through the thin film encapsulant 110. The dyad 120 may also include at least one layer having the properties of being a soft and pliable layer, accommodating changes in dimension of an active device region in a reversible manner. Examples of dyad 120 include a combination of a polymer layer for first layer 122, and a rigid moisture barrier layer such as a rigid dielectric layer or a rigid metal layer for second layer 124, or combinations of rigid metal layer and rigid dielectric layer. A rigid metal layer may include a rigid metal material such as Cu, Al, Pt, Au, or other metal. The embodiments are not limited in this context. In some embodiments, the thin film encapsulant 110 may contain at least one additional dyad, also shown as dyads 120, where the at least one additional dyad is disposed on the first dyad. In the example of FIG. 1B, four dyads are shown, while the embodiments are not limited in this context. In particular, in other embodiments a thin film encapsulant may include fewer or greater number of dyads. In some examples, a given polymer layer of a dyad may include a plurality of polymer sub-layers, where at least one polymer sub-layer is soft and pliable. Examples of soft and pliable polymer materials include silicone: hardness of ˜A40 Shore A, Young's Modulus of ˜0.9 Kpsi or ˜6.2 MPa; Parylene-C: hardness of Rockwell R80, Young's Modulus of ˜400 Kpsi or ˜2.8 GPa; Kayaku Microchem Photo-Resist (KMPR®): Young's Modulus of 1015 Kpsi or ˜7.0 GPa; polyimide: hardness of D87 Shore D, Young's Modulus of ˜2500 Kpsi or ˜17.2 GPa).

As used herein, a “soft and pliable” material may refer to a material having an elastic (Young's) modulus less than 20 GPa, for example, while a “rigid material” such as a rigid metal layer or rigid dielectric layer may have an elastic modulus greater than 20 GPa. Other characteristic properties associated with a soft and pliable material include a relatively high elongation to break, such as 70% or greater for at least one polymer layer of the thin film encapsulant. In some examples, such as silicone, a soft and pliable material may have an elongation to break up to 200% or greater.

Turning now to FIG. 2, there is shown a second instance for operation of the thin film device 100, representing, for example, a second device state of the thin film device 100. In the instance shown in FIG. 2, the thin film device 100 may represent a thin film battery in a charged state. In such a charged state the battery is charged by outdiffusing the diffusant 114, such as lithium, from the source region 104, and transporting the diffusant 114 across intermediate region 106 to accumulate at an anode, represented by the selective expansion region 108. Accordingly, the selective expansion region 108 may be expanded, where the expansion may result in a reduction in thickness of the thin film encapsulant 110 from the first thickness t₁ as represented by the discharged state of FIG. 1A to a second thickness t₂ as shown in the charged state of FIG. 2. This reduction in thickness at the thin film encapsulant 110 may be the result of the change in thickness of the anode from a third thickness t₃ in the contracted configuration of FIG. 1A to a fourth thickness t₄ in the expanded configuration of FIG. 2. In particular, the growth in thickness of the selective expansion region 108 may displace the thin film encapsulant 110, at least in a region 115, where the region 115 is adjacent the selective expansion region 108. Accordingly, the thin film encapsulant 110 may accommodate the expansion of the selective expansion region 108, by contracting from the thickness t₁ to t₂ as shown in the charged state, representing a second device state, as shown in FIG. 2.

Configurations where a polymer “layer” or more accurately a polymer layer stack includes multiple polymer sub-layers may provide advantages over configurations having just one polymer layer. For example, a three-layer polymer layer stack may have an inner polymer layer exhibiting soft and pliable properties, and outer polymer layers, where the outer polymer layers are harder and function to distribute stress more uniformly. The harder polymer layers may accordingly reduce localized abnormally high stress points, where such stress points would otherwise cause puncturing of the second layer 124, for example.

In various embodiments, the first layer 122, meaning the layer immediately adjacent the selective expansion region 108, may be designed to accommodate the entire expansion and contraction or the largest fraction of the expansion or contraction occurring in selective expansion region 108. As detailed below, this accommodation may be accomplished by choice of material or materials for the first layer 122, as well as the detailed architecture of the thin film encapsulant 110.

In some embodiments, while individual thicknesses (t₁, t₂, t₃ and t₄) may change during cycling, the thickness of the at least one polymer layer of thin film encapsulant 110 may be sufficiently large and the polymer layer sufficiently pliable, so as to accommodate the expansion and the contraction taking place during cycling. This accommodation may take place in the following manner. In particular embodiments, during cycling where t₁ and t₂ may represent opposite extremes of thickness, the thickness and pliability of the first layer 122 (or group of layers when first layer 122 is a layer stack) of thin film encapsulant 110 may be result in the following relationship. In particular, the thickness sum of t₂+t₄ is not substantially different from the thickness sum of t₁+t₃, such as a difference of less than 10%, and in some cases the thickness sum of t₂+t₄ differs from the thickness sum of t₁+t₃ by less than 5%. In this manner, the pressure on any diffusion barrier layer of the thin film encapsulant 110 is minimized. In some embodiments, the first layer 122 may constitute just one polymer layer accommodating the change in dimension of the selective expansion region 108. In other embodiments, the first layer 122 may constitute multiple polymer sub-layers, where at least one polymer sub-layer, and not necessarily other polymer sub-layers, is soft and pliable. Again, this property of the polymer sub-layer may lead to the thickness sum of t₂+t₄ being not substantially different from the thickness sum of t₁+t₃, such as a difference of less than 10%. In various embodiments, the thin film encapsulant may have an elongation property of at least 5%.

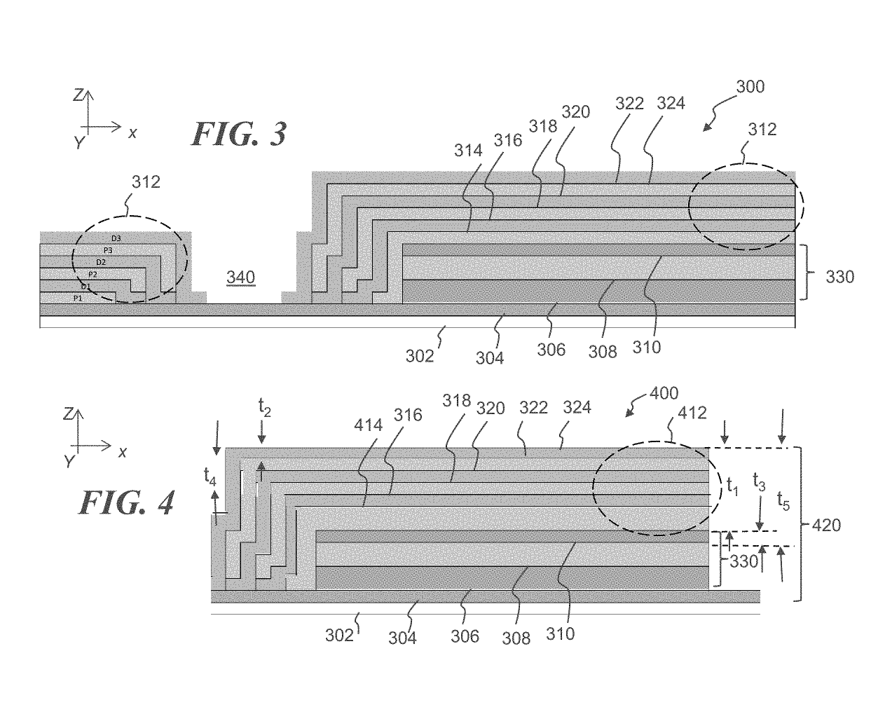

Turning now to FIG. 3 there is shown a thin film battery 300 in accordance with embodiments of the disclosure. The thin film battery 300 may include a substrate base 302, a cathode current collector 304, a cathode 306, a solid state electrolyte 308, an anode 310, and a thin film encapsulant 312, as shown. In various embodiments, the thin film encapsulant 312 may include a plurality of different layers, such as at least one dyad as generally described above. In particular, the thin film encapsulant 312 may include a layer 314, where the layer 314 is directly disposed on the anode 310. The layer 314 may be formed from a soft and pliable material, as discussed above. In particular, the layer 314 may be a polymer layer, and may include a plurality of polymer-sub-layers in some variants, where the polymer layer, or at least one polymer sub-layer is soft and pliable, as described above. In this manner, the layer 314 may accommodate changes in volume of the anode 310 as the anode 310 increases in thickness or decreases in thickness when the thin film battery 300 charges or discharges. In some embodiments, the thickness of the layer 314 (along the X-axis of the Cartesian coordinate system shown) may be between 10 μm and 50 μm. The embodiments are not limited in this context.

The thin film encapsulant 312 may further include a layer 316, where the layer 316 is disposed on the layer 314 and is not in direct contact with the anode 310. The layer 316 may be a rigid metal layer as described above, or a rigid dielectric layer composed of a known material such as silicon nitride, where the pliability of the rigid dielectric layer is much less than the pliability of layer 314. According to various embodiments, a rigid dielectric layer may have a combination of relatively high elastic modulus and hardness, for example. In the case of silicon nitride, the Vicker's hardness is ˜13 GPa, and Young's Modulus is ˜43500 Kpsi or ˜300 GPa). Accordingly, the rigid dielectric layer is less pliable than at least one polymer layer of the layer 314. Similarly, known metals having a Vicker's hardness as well as Young's modulus in excess of the values for polymer materials shown above may be used as layer 316.

The layer 316 may serve as a diffusion barrier layer, to prevent diffusion of ambient species such as H₂O (moisture) from outside the thin film battery 300 from penetrating to active device regions of the thin film battery 300, including the anode 310, solid state electrolyte 308, and cathode 306, for example. In some embodiments, the layer 316 may have a thickness of 0.25 μm to 1 μm. The layer 316 may in some variants include a plurality of rigid dielectric layers or rigid metal layers, or combinations thereof. The embodiments are not limited in this context. The layer 314 and layer 316 may together constitute a dyad, where a dyad is composed of a soft and pliable layer or layers, and a rigid dielectric layer or rigid metal layer. As illustrated in FIG. 3, the thin film encapsulant 312 may include a plurality of dyads. For example, a layer 318 is disposed on the layer 316, where the layer 318 may be a soft and pliable layer, which layer may include a plurality of polymer-sub-layers in some variants, while a layer 320 is disposed on the layer 318, where the layer 320 may be a rigid dielectric or rigid metal layer or set of layers. Accordingly, the layer 318 and layer 320 may be deemed to be a second dyad. This sequence of alternating between a soft and pliable layer and a rigid dielectric layer may be repeated, as represented, for example by layer 322 and layer 324.

In various other embodiments, a thin film encapsulant may include any number of layers, where a first layer immediately adjacent the selective expansion region of a thin film battery or other electrochemical device, is a soft and pliable layer or includes at least one soft and pliable sub-layer. At the same time a second layer disposed on the first layer is a rigid dielectric or rigid metal layer or set of layers. These configurations provide advantages over known thin film encapsulants using a rigid dielectric immediately adjacent an anode region, for example. Firstly, the thin film encapsulant 312 provides the diffusion barrier properties imparted by a rigid dielectric or rigid metal layer by virtue of incorporation of at least one rigid dielectric or rigid metal layer in a dyad composed of a soft and pliable layer in combination with a rigid dielectric layer or rigid metal layer. Additionally, because the first layer adjacent the selective expansion region is a soft and pliable layer (whether a polymer or other soft and pliable layer), the volume expansion is more easily accommodated during a charging cycle when diffusant moves into the selective expansion region (anode region). The volume expansion is especially more easily accommodated as compared to batteries configured with known thin film encapsulants where a rigid dielectric or rigid metal layer is adjacent the anode. In particular, the first layer may elastically deform to accommodate volume changes in an anode region, and may prevent cracks, delamination, or other damage from occurring in the thin film encapsulant, where such damage may otherwise occur in thin film encapsulants where an inflexible, rigid dielectric is disposed adjacent the anode. In this manner, a thin film encapsulant such as thin film encapsulant 312 may remain intact after an anode is charged to allow continued protection of the active device from attacks by ambient oxidants, where such ambient oxides would otherwise permeate through a breached thin film encapsulant.

Moreover, by providing a soft and pliable first layer adjacent the anode region, during an opposite cycle of discharging the soft and pliable first layer may expand back to release the stress and to “fill a void” where the void would otherwise occur when the diffusant (such as lithium) migrates back to a cathode. By “filling the void” when the soft and pliable first layer expands into the region being vacated by diffusant species returning to the cathode, the electrical contacts in the anode may be enhanced. This enhancement may provide longer term stability including electrical and electrochemical performance, such as stable contact resistance at the anode (selective expansion region) between the anode and electrolyte.

In accordance with various embodiments, a thin film encapsulant, such as the thin film encapsulant 312, may comprise materials having the property of being laser-etchable, and in particular may include a layer absorbent to laser radiation over a target wavelength range provided a laser. In a thin film encapsulant containing a laser-etchable material, electromagnetic radiation of a given wavelength of a laser beam is highly absorbed in the thin film encapsulant. Examples of suitable radiation wavelengths include the range from 157 nm to 1064 nm. For example, for a laser beam having a wavelength in the visible range, a transparent or completely clear-appearing polymer layer may not be highly absorbent of the electromagnetic radiation of the laser beam. For the same laser beam having wavelength in the visible range, an opaque, black, or translucent polymer layer may be highly absorbent of the electromagnetic radiation, and may accordingly be deemed a laser-etchable material. The embodiments are not limited in this context.

This property facilitates maskless patterning of the thin film encapsulant 312, where a laser is used to ablate portions of the thin film encapsulant 312 in target regions. For example, the thin film encapsulant 312 may include rigid dielectric or rigid metal layers (such as layer 316, layer 320, and layer 324) formed from silicon nitride or similar material, or a rigid metal layer, such as Cu, (or Cu). In these materials strong electromagnetic radiation absorption may take place in the wavelength range of 157 nm to 1064 nm to accommodate processing by known lasers generating radiation in at least a portion of the aforementioned wavelength range. Similarly, the layer 314, layer 318, and layer 322 may be formed of a polymer, where the polymer also strongly absorbs electromagnetic radiation over a similar wavelength range. Accordingly, a thin film encapsulant may be patterned as shown in FIG. 3, where the thin film encapsulant 312 conformally coats an active device region 330 to form a thin film battery, while being isolated from other structures by the region 340, formed by laser etching of the layers of the thin film encapsulant 312. In particular embodiments, the etchability of known polymer materials used in the thin film encapsulant 312 may be enhanced as needed where such polymer materials may have relatively lower absorption of laser radiation. For example, a known polymer such as silicone may have etchability enhanced by adding a dye to the polymer to increase radiation absorption, or may be placed between two layers, where the two layers are more highly etchable by a given laser.

Turning now to FIG. 4 there is shown a thin film battery 400 in accordance with other embodiments of the disclosure. The thin film battery 400 may include a substrate base 302, a cathode current collector 304, a cathode 306, a solid state electrolyte 308, and an anode 310, as described above with respect to FIG. 3. The illustration in FIG. 4 may represent a discharged state of the thin film battery 400. The thin film battery 400 also includes thin film encapsulant 412, as shown. In various embodiments, the thin film encapsulant 412 may include a plurality of different layers, such as at least one dyad as generally described above with respect to FIG. 3. In the architecture shown in FIG. 4, the thin film encapsulant 412 includes a first layer, shown as layer 414. The layer 414 is disposed immediately adjacent the anode 310 and is made of a soft and pliable material, such as a polymer, or may include multiple sub-layers, where at least one sub-layer of layer 414 is soft and pliable. In some embodiments of the thin film encapsulant 412 illustrated in FIG. 4, the layer 414 may be composed of a similar material as in layer 318 and layer 322.

According to some embodiments the layer thickness may vary among different layers of a thin film encapsulant. A hallmark of the thin film encapsulant 412 is the relative thickness of the layer 414. In particular, the thickness of the layer 414 may be designed to accommodate a large fraction, if not all, of the volume change taking place in anode 310 when the thin film battery 400 charges and discharges. The thickness of the layer 414 may be designed to be greater than the thickness of other layers in the thin film encapsulant 412. For example, the thickness of layer 414 may be between 20 μm and 50 μm, while the thickness of the rigid dielectric or rigid metal layers, layer 316, layer 320, and layer 324 is 5 μm or less. Moreover, the thickness of additional soft and pliable layers of the thin film encapsulant 412, such as layer 318 and layer 322, may be 20 μm or less. The embodiments are not limited in this context. Altogether, in some embodiments the thickness of the device stack 420, including the active device region 330 and thin film encapsulant 412 may be approximately 80 to 120 μm, and in some embodiments may be 50 to 80 μm. The embodiments are not limited in this context.

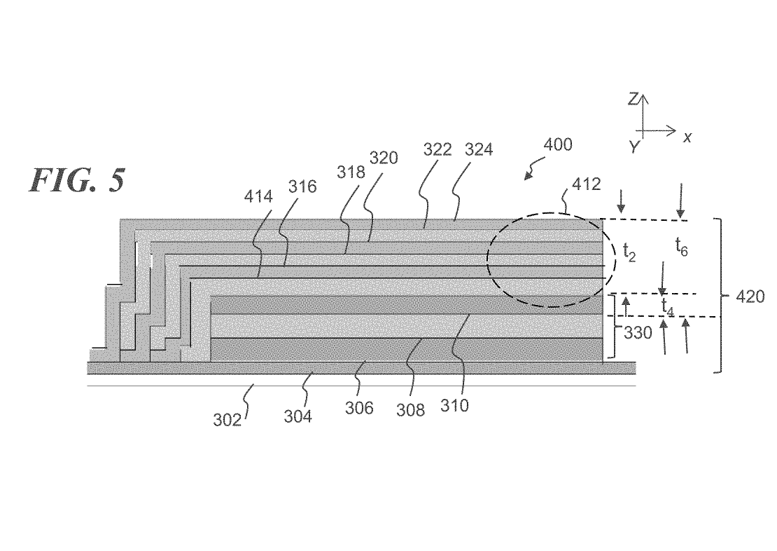

Turning now to FIG. 5, there is shown another depiction of the thin film battery 400, representing a charged state. As noted previously, in Li thin film batteries where a cathode is a solid state cathode formed from LiCoO₂ having a thickness 15 μm to 17 μm thick, the amount of lithium transported between cathode and anode during charging may be the equivalent of a 6 μm layer of Li. Accordingly, by arranging a first layer of a thin film encapsulant 412 to be soft and pliable and to have thickness in the range up to 50 μm, such an increase in thickness in the anode 310 may be more easily accommodated while not causing cracking, delamination or other problems. At the same time, the thickness of the additional layers of the thin film encapsulant 412, including additional soft and pliable layers, may be maintained at relatively lower values, because most or all of the deformation in the anode 310 may be accommodated by the reversible elastic deformation in the first layer. This circumstance is illustrated in FIG. 5, where the layer 414 is elastically compressed along the Z-axis (compare with FIG. 4), while the other layers of the thin film encapsulant 412 are not compressed or otherwise damaged, maintaining their original dimensions with little or no stress. In particular embodiments, during cycling where t₁ and t₂ may represent opposite extremes of thickness for thin film encapsulant 412, the thickness and pliability of the layer 414 of thin film encapsulant 412 may result in the following. The thickness sum of t₂+t₄ (shown as t₆ in FIG. 5) may be not substantially different from the thickness sum of t₁+t₃, (shown as t₅ in FIG. 4) such as a difference of less than 10%.

In this manner, the thin film battery 400 may provide an improved performance compared to known thin film batteries by providing the following features. Firstly, multiple rigid dielectric or rigid metal layers are provided to act as diffusion barriers. Secondly, a layer, the “first layer,” is provided immediately adjacent to an anode to directly absorb the deformation in the anode caused during charging and discharging of the battery, all within a compact device structure (50 μm-100 μm). By absorbing all or most of the deformation of a subjacent layer or layers within an active device within the first layer of a thin film encapsulant, the first layer may prevent the remaining layers including diffusion barriers from deformation, or may greatly reduce the deformation of such layers.

In various additional embodiments, a thin film battery, and in particular, a thin film encapsulant disposed within a thin film battery, may include a polymer layer that is made from a plurality of polymer sub-layers, where the mechanical properties differ between different polymer sub-layers. Examples of differing mechanical properties include differing hardness (or softness), different elongation to break, and other properties. Such a polymer layer, accordingly may be considered as a composite, and may confer a combination of properties not readily achieved by a polymer layer composed of just one uniform material that does not have sub-layers of differing properties. As used hereinafter the term “hardness” within the context of a polymer layer may refer to any combination of hardness as measured by standard hardness measurements (Rockwell, Shore, and the like) or elastic modulus.

Moreover, particular arrangements of polymer sub-layers within a polymer layer, as described below in the embodiments of FIG. 6-8D, may confer unexpected advantages to batteries arranged with such a polymer layer in a thin film encapsulant. As an example, the present inventors have found that the capacity retention over life cycle is improved in thin film batteries where a polymer layer of a thin film encapsulant is arranged as a two-layer structure or three layer structure. As used herein “capacity retention over life cycle” refers to the remaining battery capacity vs. the initial battery capacity at a given cycle life, in percentage. The improved capacity retention over life cycle provided by the present embodiments illustrates the improved protective function of such polymer sub-layer configurations. In particular, the improved capacity retention over life cycle shows that lithium present at the anode is less susceptible to oxidation, which process renders the lithium inactive in the battery. The increased oxidation resistance provided by the present embodiments, in turn, may be related to improved integrity including improved mechanical integrity of a TFE arranged with a polymer layer composed of multiple polymer sub-layers.

In particular, the two layer structure or three layer structure of a polymer includes two or three polymer sub-layers, where at least one polymer sub-layer is relatively softer than another polymer sub-layer.

Turning now to FIG. 6 there is shown an embodiment of a thin film battery structure 600 that may form part of a thin film battery as detailed above. In FIG. 6 a layer representing the selective expansion region 108 is shown, where the selective expansion region 108 may be an anode or anode current collector as described above. Other layers battery (not shown) of a thin film may be disposed below the selective expansion region 108, such as layers of the active device region of a battery, as detailed in the aforementioned embodiments. Moreover, additional layers of a thin film encapsulant may be disposed on top of the thin film battery structure 600, such as any combination of rigid dielectric layers and rigid metal layers.

In this embodiment, the thin film battery structure 600 includes a polymer layer 610, disposed on the selective expansion region 108. In this embodiment, the polymer layer 610 is made of a plurality of sub-layers, shown as sub-layer 604, sub-layer 606, and sub-layer 608. In various embodiments, the polymer layer 610 is arranged as a three-layer polymer layer stack, just as shown. The polymer layer 610 may have an inner polymer sub-layer, represented by sub-layer 606, where the inner polymer sub-layer exhibits soft and pliable properties. The sub-layer 604 and sub-layer 608 of polymer layer 610 may represent outer polymer sub-layers, where the outer polymer sub-layers are harder and function to distribute stress more uniformly. The harder polymer sub-layers may accordingly reduce localized abnormally high stress points during operation of the thin film battery structure 600, where such stress points may otherwise cause puncturing or other failure within the thin film battery structure 600. The impact of anisotropic stress may manifest itself on a rigid, permeation blocking layer (not shown) situated above the thin film battery structure 600. If breached, then the break point in the rigid, permeation blocking layer can provide unimpeded path for ambient oxidants to penetrate.

In some embodiments the sub-layer 604 and the sub-layer 608 may be formed from the same material. Notably, the impact of anisotropic stress may be manifested in rigid, permeation blocking layers (not shown) arranged on top of the sub-layer 608, for example. If breached, then the break point a rigid, permeation blocking layer will provide unimpeded path for ambient oxidants to reach reactive materials in the selective expansion region 108.

In one particular embodiment the sub-layer 604 and the sub-layer 608 may be made of Kiyaku-Microchem Photo-resist (KMPR®), while the sub-layer 606 may be a silicone layer. The embodiments are not limited in this context. More generally, the sub-layer 604 and the sub-layer 608 may exhibit hardness that is greater than the hardness of sub-layer 606, so the relative hardness of the inner region of the polymer layer 610 may be less than the relative hardness of the outer region, as represented by the sub-layer 604 together with the sub-layer 608. Notably, the total thickness of the polymer layer 610 as well as the individual thicknesses of the sub-layers of the polymer layer 610 may scale with the thickness of the layers of an active device region to be encapsulated. As an example, for thin film batteries having a lithium-containing cathode where the amount of lithium transported during charging and discharging is approximately 6 micrometers, the total thickness of the polymer layer 610 may range from 10 μm to 100 μm. The embodiments are not limited in this context. The thickness of an individual sub-layer of the polymer layer 610 may range between 5 μm and 50 μm.

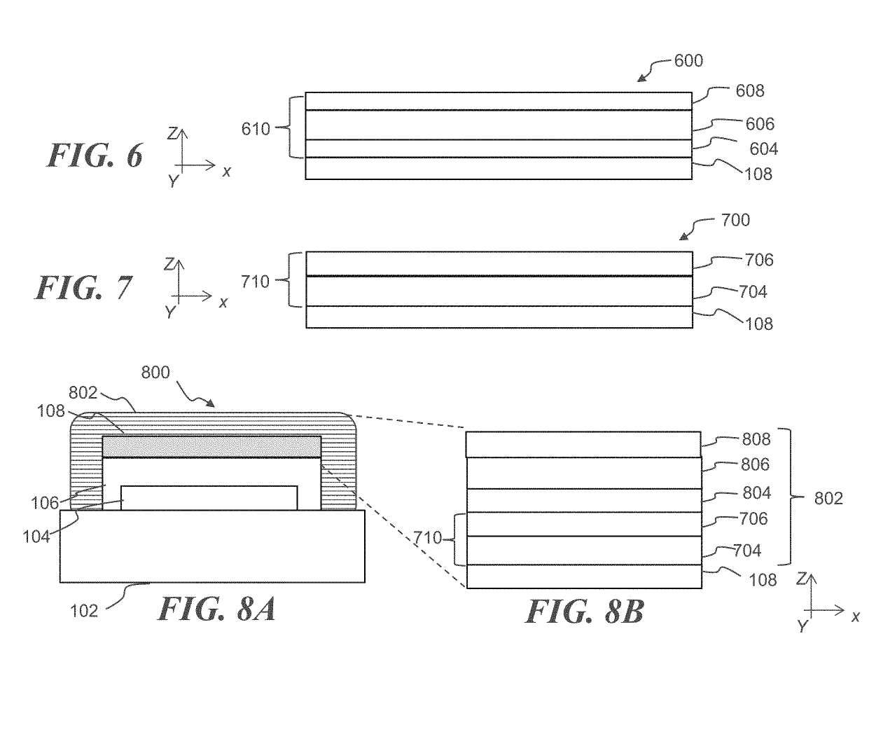

Turning now to FIG. 7 there is shown another embodiment of a thin film battery structure 700 that may form part of a thin film battery, such as in the embodiments as detailed above. In FIG. 7 a layer representing the selective expansion region 108 is shown. The selective expansion region 108 may be an anode or anode current collector as described above. Other layers (not shown) of a thin film battery may be disposed below the selective expansion region 108, such as layers of the active device region of a battery, as detailed in the aforementioned embodiments. Moreover, additional layers of a thin film encapsulant may be disposed on top of the thin film battery structure 700, such as any combination of rigid dielectric layers and rigid metal layers.

In this embodiment, the thin film battery structure 700 includes a polymer layer 710, disposed on the selective expansion region 108. In this embodiment, the polymer layer 710 is made of a plurality of sub-layers, shown as sub-layer 704 and sub-layer 706. In some embodiments, the sub-layer 704 may represent a relatively softer polymer material while the sub-layer 706 represents a relatively harder polymer material. The relatively softer sub-layer, sub-layer 704, being arranged immediately adjacent the selective expansion region 108, may accommodate all or most of the expansion and contraction that may take place when a diffusant, that is, a charge carrier of the thin film battery structure 700, diffuses in and out of the selective expansion region 108.

In one particular embodiment the sub-layer 704 may be made of parylene-C while the sub-layer 706 is made of KMPR. In another example the sub-layer 704 may be a silicone layer, while the sub-layer 706 is made of KMPR. In one particular embodiment, the silicone may be a “black” silicone layer that includes a carbon black or similar filler, imparting greater absorption to electromagnetic radiation, such as laser radiation that is used to pattern a thin film encapsulant containing the polymer layer 710. Similarly, a silicone sub-layer of polymer layer 610 may also be black silicone. 610 also.

The total thickness of the polymer layer 710 as well as the individual thicknesses of the sub-layers of the polymer layer 710 may scale with the thickness of the layers of an active device region to be encapsulated. As with the example of FIG. 6, in some embodiments, the total thickness of the polymer layer 710 may range from 10 μm to 100 μm, while the thickness of an individual sub-layer of the polymer layer 710 may range between 5 μm and 50 μm. By providing the polymer layer 710 as a composite of two sub-layers, where the upper sub-layer, sub-layer 706 is harder than the lower sub-layer, sub-layer 704, the integrity of a thin film battery, and in particular the integrity of a thin film encapsulant may be improved. The improvement in integrity may be demonstrated by reduced cracking or elimination of cracking in thin film batteries, as well as improved cycle retention.

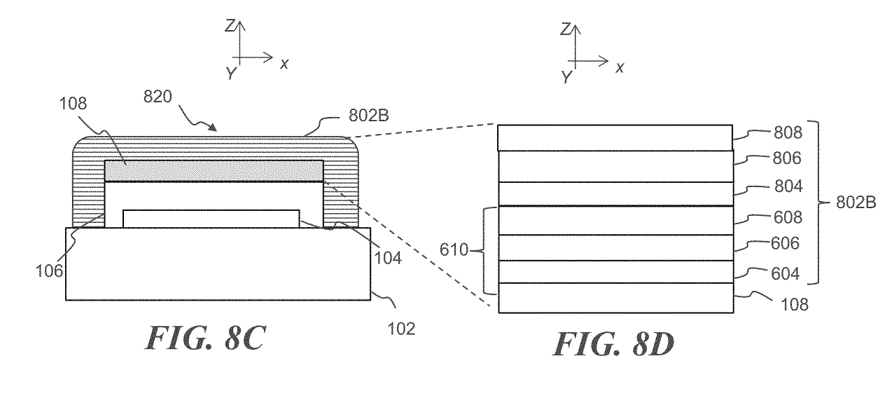

Turning now to FIG. 8A there is shown an embodiment of a thin film battery 800, according to various embodiments of the disclosure. The thin film battery 800 may include a source region 104, an intermediate region 106 disposed on the source region 104, and a selective expansion region 108 disposed on the intermediate region 106, as described above. For example, the source region 104 may be deemed a cathode, the intermediate region 106 may include a solid state electrolyte, while the selective expansion region 108 includes an anode or anode current collector.

The thin film battery 800 may include a thin film encapsulant 802, composed of a plurality of layers, as depicted in more detail in FIG. 8B. In this embodiment the thin film encapsulant 802 includes the polymer layer 710, as described above, where the polymer layer 710 is disposed directly on the selective expansion region 108. The thin film encapsulant 802 may further include a layer 804 disposed on the polymer layer 710, layer 806 disposed on the layer 804, and a layer 808 disposed on the layer 806, as shown. The layer 804 may be a rigid layer that acts as a permeation blocking barrier, such as a rigid metal layer or rigid dielectric layer. The layer 806 may be a second polymer layer, while the layer 808 is another rigid layer, such as a rigid metal layer or rigid dielectric layer.

In operation, the thin film battery 800 may cycle between charged and discharged states where diffusant is transported between source region 104 and selective expansion region 108, alternately causing an expansion and contraction in the selective expansion region 108. This expansion and contraction may generate forces within the thin film encapsulant 802, where the forces are accommodated by deformation within the thin film encapsulant 802, generally as described above with respect to FIGS. 1A-5. In particular, the expansion and contraction may be accommodated by countering deformation within the polymer layer resulting in a contraction and expansion of the polymer layer 710. Because the polymer layer 710 is a composite of two sub-layers, where the sub-layer 704 is relatively softer, while the sub-layer 706 is relatively harder, the expansion and contraction in selective expansion region 108 may be accommodated in a manner preventing delamination, cracks, or other failure within the layers of the thin film encapsulant 802.

In an alternative embodiment shown in FIG. 8C and FIG. 8D a thin film battery 820 may include a thin film encapsulant 802B that includes the polymer layer 610, as described above, where the polymer layer 610 is disposed directly on the selective expansion region 108. The expansion and contraction generated during operation of thin film battery 800 in this embodiment may generate forces within the thin film encapsulant 802B, where the expansion and contraction may be accommodated by countering deformation within the polymer layer result in a contraction and expansion of the polymer layer 610. Because the polymer layer 610 is a composite of three sub-layers, where the sub-layer 606 is relatively softer, while the sub-layer 608 and sub-layer 604 are relatively harder, the expansion and contraction in selective expansion region 108 may be accommodated in a manner preventing delamination, cracks, or other failure within the layers of the thin film encapsulant 802B.

Notably, in the embodiments of FIGS. 8A-8D, the layer 806 may include multiple polymer sub-layers, analogous to polymer layer 610, or alternatively to polymer layer 710, for example. The inclusion of multiple polymer sub-layers within layer 806 may ensure integrity of a TFE in the event that a first polymer layer, such as polymer layer 610 or polymer layer 710, is insufficient over the life of a battery for maintaining the integrity of the TFE, with respect to permeation blocking.

In different configurations, the sub-layer structure of a second polymer layer may be similar or different to the sub-layer structure of a first polymer layer. For example, in some embodiments, where a first polymer layer is deemed to have a first plurality of polymer sub-layers, a second polymer layer may include a second plurality of polymer sub-layers. In some instances, a first polymer sub-layer of the second plurality of polymer sub-layers may have a fourth hardness, where a second polymer sub-layer of the second plurality of polymer sub-layers comprises a fifth hardness, where the fourth hardness is different from the fifth hardness. In some examples, the fourth hardness may equal a first hardness of a first polymer sub-layer of a first polymer layer, while the fifth hardness equals a second hardness of a second polymer sub-layer of the first polymer layer. The embodiments are not limited in this context.

In some embodiments, the second polymer layer may comprise a two-layer structure, where a first polymer sub-layer of the two layer structure is disposed on the first rigid layer; and where the second polymer sub-layer is disposed on the first polymer sub-layer, wherein the fourth hardness is less than the fifth hardness.

In additional embodiments, the second polymer layer may comprise a three-layer structure that includes a first polymer sub-layer, where the first polymer sub-layer is disposed on the first rigid layer, and further includes a second polymer sub-layer, where the second polymer sub-layer is disposed on the first polymer sub-layer and has the fifth hardness. A third polymer sub-layer of the three-layer structure may be disposed on the second polymer sub-layer and may have a sixth hardness, where the fifth hardness is less than the fourth hardness and the sixth hardness.

In some embodiments, a first polymer layer and a second polymer layer of a thin film encapsulant may comprise a plurality of polymer sub-layers, where the configuration of sub-layers in the first polymer layer is the same as the configuration in the second polymer layer. For example, a first polymer layer may be composed of polyimide/silicone/polymide sub-layers, while the second polymer layer is also composed of polyimide/silicone/polyimide sub-layers. In particular embodiments, the thickness of the various polymer sub-layers within a first polymer layer may match the thickness of polymer sub-layers within a second polymer layer.

In other embodiments, a second polymer layer may have a configuration of sub-layers that differs from the configuration of sub-layers of a first polymer layer. For example, the first polymer layer may have a two-layer configuration while the second polymer layer has a three-layer configuration.

In other embodiments, the layer 806 may be a uniform polymer layer, meaning that the layer 806 is not composed of a plurality of polymer sub-layers, where the properties differ among different polymer sub-layers. In either case, the thin film encapsulant 802 or thin film encapsulant 802B may be arranged wherein the changes in dimension of the selective expansion region 108 are accommodated within the first polymer layer, that is, within layer 710 or layer 610, respectively. Accordingly, additional polymer layers within a given thin film encapsulant may be arranged as uniform polymer layers, not having to accommodate the changes in the selective expansion region 108. Moreover, while the thin film encapsulant 802 or thin film encapsulant 802B are shown having just four layers (counting layer 710 and layer 610 as just one layer), in other embodiments a thin film encapsulant having a first polymer layer composed of multiple polymers sub-layers may exhibit more or fewer total layers.

In embodiments where the thin film encapsulant includes more than four layers, the additional layers may be arranged to improve permeation blocking capability, and may include additional dyads, as described above. For example, one or more dyads may be added to the thin film encapsulant 802 or thin film encapsulant 802B, where a given dyad includes a polymer layer and a rigid layer, acting as a permeation blocking layer.

In the aforementioned embodiments of FIGS. 6-8B, while certain specific compositions for polymer sub-layers have been noted, the embodiments of the present disclosure are not so limited. As an example, the same material may be used as a relatively harder sub-layer in one implementation of a polymer layer, and may be used as a relatively softer sub-layer in another implementation of a polymer layer. As an example, a given polymer sub-layer having a Young's modulus intermediate to the Young's modulus of parylene and KMPR may serve as the “hard” polymer sub-layer when paired with parylene acting as a soft polymer sub-layer in a given polymer layer. The same given polymer may serve as the “soft” polymer sub-layer when paired with KMPR acting as a hard polymer sub-layer within another polymer layer.

There are multiple advantages provided by the present embodiments, including the ability to reduce the thickness of non-active packaging materials such as thin film encapsulants used in a thin film device, leading to enhanced energy density of these devices. A further advantage lies in improving the robustness ability of a thin film device encapsulant, where the thin film device is patternable by a maskless process.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, the present disclosure has been described herein in the context of a particular implementation in a particular environment for a particular purpose, while those of ordinary skill in the art will recognize the usefulness is not limited thereto and the present disclosure may be beneficially implemented in any number of environments for any number of purposes. Thus, the claims set forth below are to be construed in view of the full breadth and spirit of the present disclosure as described herein.

What is claimed is:

1. A thin film device, comprising:
an active device region, the active device region comprising a selective expansion region; and
a polymer layer disposed adjacent to the active device region and encapsulating the active device region, the polymer layer comprising a plurality of polymer sub-layers, wherein a first polymer sub-layer of the plurality of polymer sub-layers has a first hardness, and wherein a second polymer sub-layer of the plurality of polymer sub-layers has a second hardness, the second hardness being different from the first hardness.

2. The thin film device of claim 1, wherein the polymer layer comprises a two-layer structure, comprising:
the first polymer sub-layer, the first polymer sub-layer being disposed on the selective expansion region; and
the second polymer sub-layer, the second polymer sub-layer being disposed on the first polymer sub-layer, wherein the first polymer sub-layer is disposed between the second polymer sub-layer and the selective expansion region,
wherein the first hardness is less than the second hardness.

3. The thin film device of claim 2, wherein the first polymer sub-layer comprises parylene or silicone.

4. The thin film device of claim 2, wherein the second polymer sub-layer comprises KMPR.

5. The thin film device of claim 1, wherein the polymer layer comprises a three-layer structure, comprising:
the first polymer sub-layer, the first polymer sub-layer being disposed on the selective expansion region;
the second polymer sub-layer, the second polymer sub-layer being disposed on the first polymer sub-layer, wherein the first polymer sub-layer is disposed between the second polymer sub-layer and the selective expansion region; and
a third polymer sub-layer, the third polymer sub-layer being disposed on the second polymer sub-layer and further comprising a third hardness, wherein the second polymer sub-layer is disposed between the first polymer sub-layer and the third polymer sub-layer,
wherein the second hardness is less than the first hardness and the third hardness.

6. The thin film device of claim 5, wherein the first polymer sub-layer and the third polymer sub-layer comprise Kayaku Microchem Photo-Resist (KMPR), and wherein the second polymer sub-layer comprises silicone or parylene.

7. The thin film device of claim 5, wherein the first polymer sub-layer and the third polymer sub-layer comprise KMPR, and wherein the second polymer sub-layer comprises silicone or parylene.

8. The thin film device of claim 1, wherein the selective expansion region comprises an anode of a thin film battery, the active device region further comprising:
a lithium-containing cathode; and
a solid state electrolyte, the solid state electrolyte being disposed between the lithium-containing cathode and the anode.

9. The thin film device of claim 1, wherein the polymer layer is a first polymer layer, the thin film device further comprising:
a first rigid layer, disposed on the first polymer layer;
a second polymer layer, disposed on the first rigid layer; and
a second rigid layer, disposed on the second polymer layer.

10. The thin film device of claim 9, wherein the second polymer layer is a uniform polymer layer.

11. The thin film device of claim 9, wherein the second polymer layer comprises a second plurality of polymer sub-layers, wherein a first polymer sub-layer of the second plurality of polymer sub-layers has a fourth hardness, and wherein a second polymer sub-layer of the second plurality of polymer sub-layers comprises a fifth hardness, wherein the fourth hardness is different from the fifth hardness.

12. The thin film device of claim 11, wherein the second polymer layer comprises a two-layer structure,
the first polymer sub-layer being disposed on first rigid layer; and
the second polymer sub-layer being disposed on the first polymer sub-layer,
wherein the fourth hardness is less than the fifth hardness.

13. The thin film device of claim 11, wherein the second polymer layer comprises a three-layer structure, comprising:
the first polymer sub-layer, the first polymer sub-layer being disposed on the first rigid layer;
the second polymer sub-layer, the second polymer sub-layer being disposed on the first polymer sub-layer; and
a third polymer sub-layer, the third polymer sub-layer being disposed on the second polymer sub-layer and further comprising a sixth hardness, wherein the second polymer sub-layer is disposed between the first polymer sub-layer and the third polymer sub-layer,
wherein the fifth hardness is less than the fourth hardness and the sixth hardness.

14. The thin film device of claim 9, wherein the first rigid layer comprises a rigid metal layer or a rigid dielectric layer, and wherein the second rigid layer comprises a rigid metal layer or a rigid dielectric layer.

15. The thin film device of claim 1, wherein the polymer layer comprises a thickness of 10 μm to 100 μm.

16. The thin film device of claim 1, wherein a thickness of at least one of the first polymer sub-layer and the second polymer sub-layer is between 5 μm and 50 μm.

17. The thin film device of claim 9, further comprising:
at least one dyad, the at least one dyad disposed on the second rigid layer and comprising:
another polymer layer, disposed on the second rigid layer; and
another rigid layer, disposed on the another polymer layer.

18. A thin film battery, comprising:
an active device region, the active device region comprising:
a lithium-containing cathode;
a solid state electrolyte, disposed on the lithium-containing cathode; and
an anode disposed on the solid state electrolyte; and
a thin film encapsulant disposed adjacent to the anode and encapsulating at least a portion of the active device region, the thin film encapsulant comprising:
a first polymer layer, the first polymer layer comprising a plurality of polymer sub-layers, wherein a first polymer sub-layer of the plurality of polymer sub-layers has a first hardness, and wherein a second polymer sub-layer of the plurality of polymer sub-layers has a second hardness, the second hardness being different from the first hardness; and
a rigid layer, disposed on the first polymer layer.

19. A thin film battery, comprising:
a lithium-containing cathode;
a solid state electrolyte, disposed on the lithium-containing cathode;
an anode disposed on the solid state electrolyte, the anode comprising a selective expansion region; and
a thin film encapsulant disposed adjacent to the anode, the thin film encapsulant comprising:
a first polymer layer, the first polymer layer further comprising:
a first polymer sub-layer, disposed on the selective expansion region, the first polymer sub-layer having a first hardness;
a second polymer sub-layer, disposed on the first polymer sub-layer, the second polymer sub-layer having a second hardness, the second hardness being different from the first hardness;
a first rigid layer, disposed on the first polymer layer;
a second polymer layer disposed on the first rigid layer; and
a second rigid layer disposed on the second polymer layer.
